(19) United States
(12) Patent Application Publication
(10) Pub. No.: US 2016/0001836 A1
(43) Pub. Date: Jan. 7, 2016

(54) INTELLECTUAL BICYCLE LAMP

(71) Applicant: Wen-Sung Lee, Taichung City (TW)

(72) Inventor: Wen-Sung Lee, Taichung City (TW)

(21) Appl. No.: 14/321,837

(22) Filed: Jul. 2, 2014

(51) Int. Cl. B62J 6/00; B62J 6/16; F21V 23/00; F21V 23/04; F21V 13/04

(52) U.S. Cl. CPC B62J 6/003; F21V 23/0464; F21V 23/0492; F21V 13/04; F21V 23/003; B62J 6/16; F21W 2101/023

(57) ABSTRACT

A bicycle lamp includes a lamp body and an control module. The lamp body has a light source disposed therein. The control module is electrically connected to the light source for controlling the light source, and has a vibration sensor for detecting a vibration from the lamp body. Wherein, the light source is turned on by the control module once the vibration sensor detects the vibration from the lamp body during riding, and the light source is turned off once the vibration sensor detect no vibration from the lamp body.

### BACKGROUND OF THE INVENTION

1. Field of the Invention

The present invention relates to a bicycle lamp, and more particularly to an intellectual bicycle lamp that provides an automatic light control system for a rider.

2. Description of Related Art

Cycling becomes a type of life during the past years and the people love to use bicycles to be one of the options of transportation and exercises. However, safety is always the first concern when riding the bicycles and the light assembly is one of the top optional choices of the bicycles. The light assembly is assembled to the frame of the bicycle and provides illumination to see the roads and also allow the cyclist to be seen by others. Most of the conventional bicycle light assemblies are powered by batteries which have limited lift of use so that the batteries have to be replaced frequently. Therefore, how to prolong the usage time of the bicycle light is continuously progressing.

Generally, the conventional bicycle light cannot automatically regulate illumination of the light source according to the intensity of the surrounding brightness or the usage state so as to improve unnecessary electrical consumption.

The present invention has arisen to mitigate and/or obviate the disadvantages of the conventional bicycle light.

### SUMMARY OF THE INVENTION

The main objective of the present invention is to provide an improved bicycle light.

To achieve the objective, a bicycle lamp comprises a lamp body and a control module. The lamp body has a light source disposed therein. The control module is electrically connected to the light source for controlling the light source, and has a vibration sensor for detecting a vibration from the lamp body. Wherein the light source is turned on by the control module once the vibration sensor detects the vibration from the lamp body during riding, and the light source is turned off once the vibration sensor detect no vibration from the lamp body.

Preferably, an ambient light sensor is electrically connected to the light source and configured to detect an intensity of surrounding brightness and to control illumination of the light source according to the detected intensity of the surrounding brightness.

Preferably, the lamp body comprises a reflecting cup disposed around the light source, a focusing lens disposed at a front side of the reflector cup opposite to the light source, and a switch disposed on the lamp body and electrically connected to the control module for manually controlling the control module.

Preferably, the control module has a control circuit storing a plurality of control programs for controlling the light source. The control programs of the control circuit include a flash mode in which the light source is flashed, a sleep mode in which the light source is temporarily off, and a hibernate mode in which the light source is turned off

Further benefits and advantages of the present invention will become apparent after a careful reading of the detailed description with appropriate reference to the accompanying drawings.

### BRIEF DESCRIPTION OF THE DRAWINGS

FIG. 1 is a block diagram of a bicycle lamp in accordance with a preferred embodiment of the present invention;

FIG. 2 is a perspective view of the bicycle lamp of the present invention, wherein the bicycle lamp is attached to a bicycle;

FIG. 3 is a partial enlarged view of FIG. 2;

FIG. 4 illustrates that the bicycle lamp is lighted up during riding;

FIG. 5 illustrates that the illumination of the bicycle lamp is automatically regulated under low intensity of the surrounding brightness; and

FIG. 6 illustrates that the illumination of the bicycle lamp is automatically regulated under high intensity of the surrounding brightness.

### DETAILED DESCRIPTION OF THE INVENTION

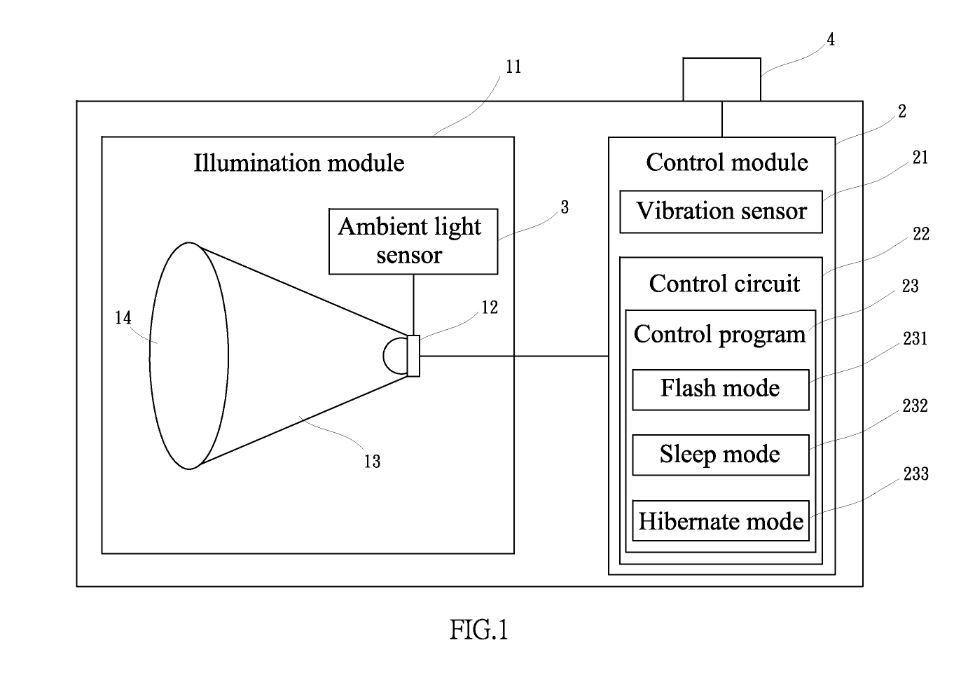

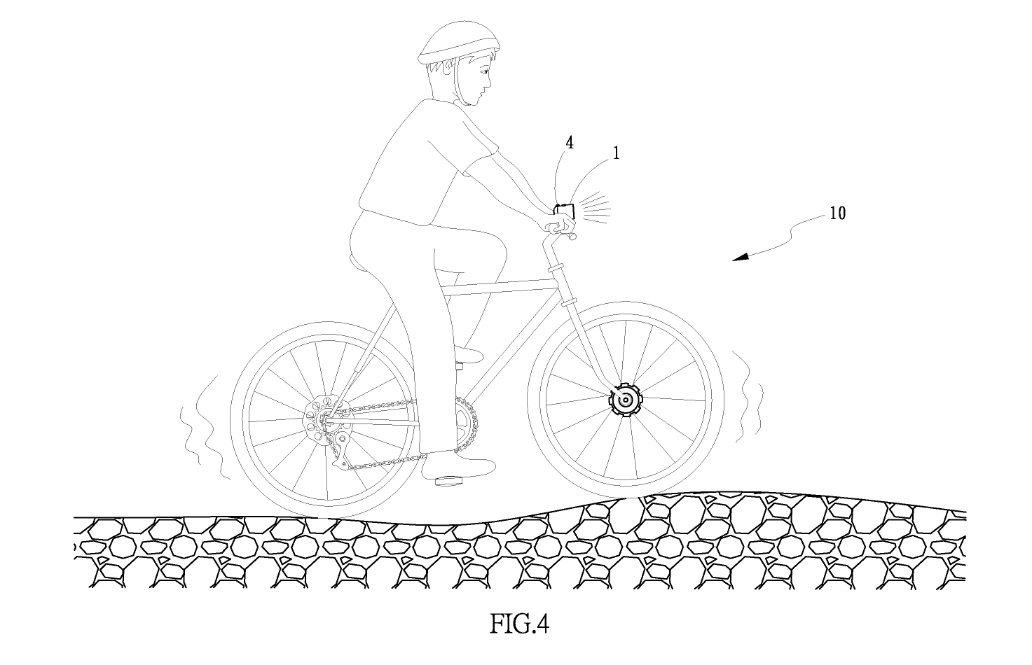

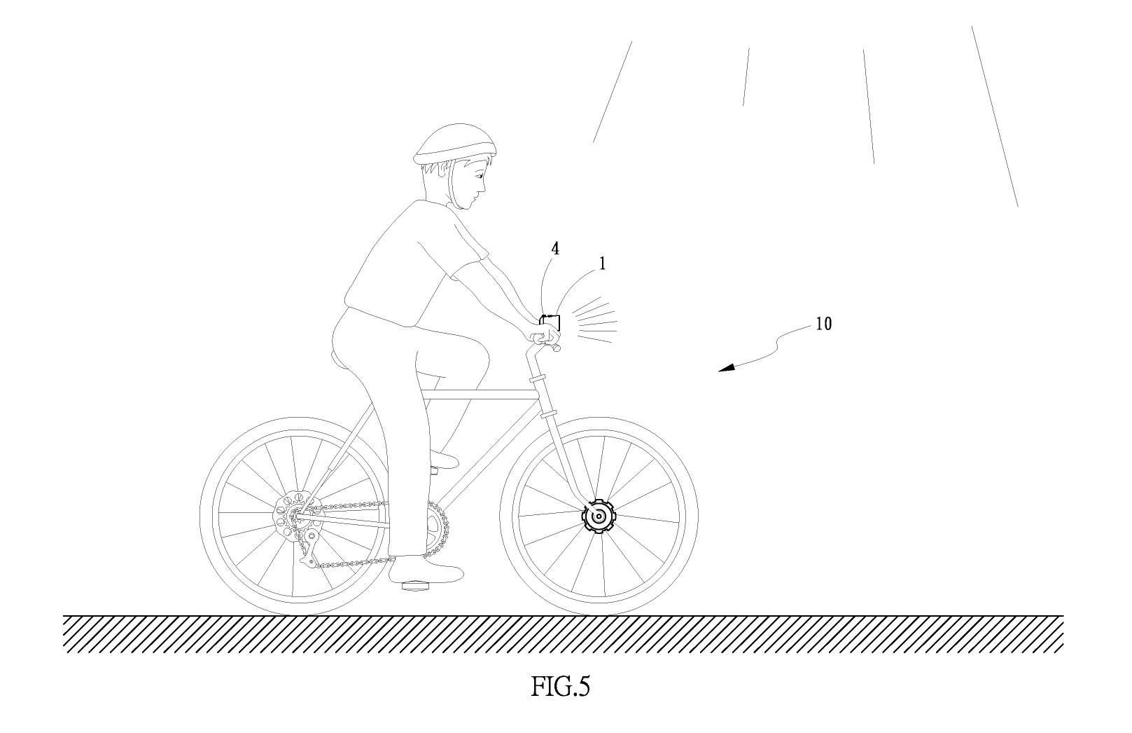

Referring to FIGS. 1-4, an intellectual bicycle lamp in accordance with a preferred embodiment of the present invention comprises a lamp body 1 and a control module 2. The lamp body 1 has an illumination module 11 disposed therein and a light source 12 disposed in the illumination module 11. The control module 2 is disposed in the lamp body 11 and electrically connected to the light source 12 for controlling the light source 12. Specifically, the control module 2 has a vibration sensor 21 for detecting a vibration from the lamp body 1.

Under this arrangement, the light source 12 is turned on by the control module 2 once the vibration sensor 21 detects the vibration from the lamp body 1 during riding, and the light source 12 is turned off once the vibration sensor 21 detect no vibration from the lamp body 1.

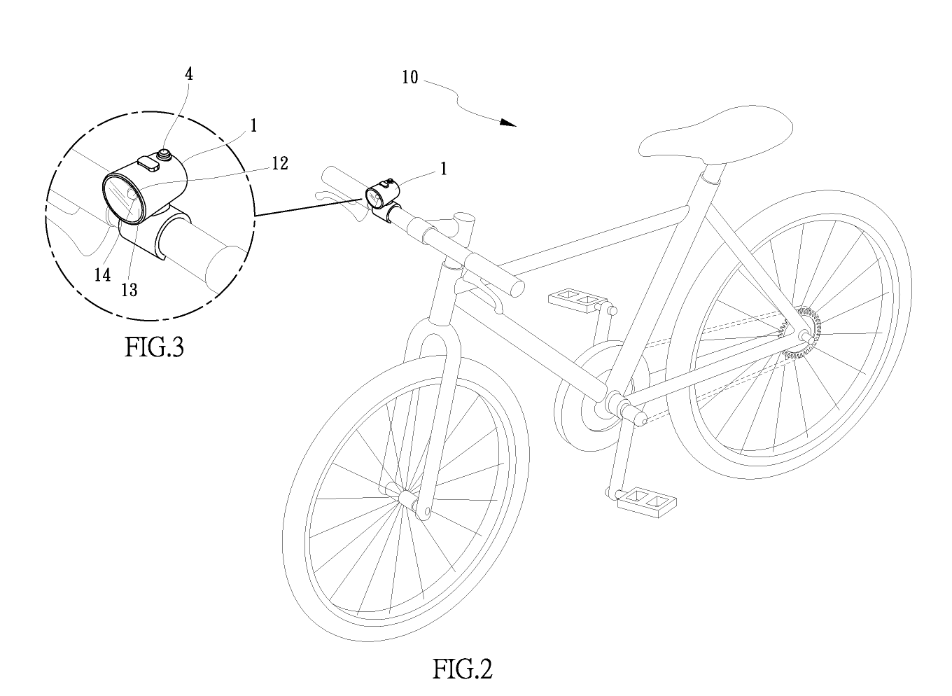

The bicycle lamp is mounted on a handlebar of a bicycle 10, as shown in FIGS. 2-3. The vibration sensor 21 is configured to detect the vibration of the lamp body 1 to judge whether the bicycle is nm or not.

When a rider rides the bicycle 10, the vibration sensor 21 would detect the vibration of the lamp body 1 from the bicycle and the light source 12 would be continuously lighted up. In contrast, when the bicycle 10 is at rest, the vibration sensor 21 would detect no vibration from the lamp body 1 and the light source 12 would be turned off so as to save power for prolonging the usage time of the bicycle lamp.

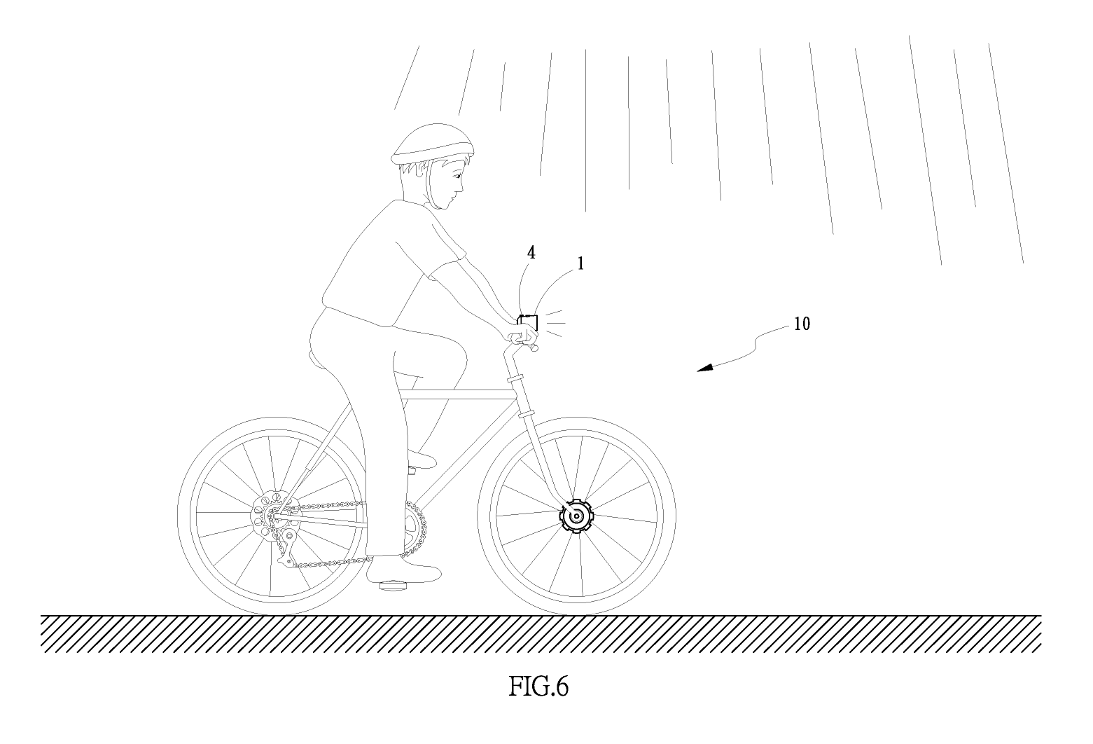

As sown in FIG. 1 and referring to FIGS. 5-6, the lamp body 1 has an ambient light sensor 3 electrically connected to the light source 12. The ambient light sensor 3 is configured to detect an intensity of surrounding brightness and to control illumination of the light source 12 according to the detected intensity of the surrounding brightness, as shown in FIGS. 5-6.

Furthermore, as shown in FIG. 1, the lamp body 1 further comprises a reflecting cup 13 disposed around the light source 12, and a focusing lens 14 disposed at a front side of the reflector cup 13 opposite to the light source 12. The reflecting cup 13 is configured to redirect the light of the light source 12 towards the focusing lens 14 so as to focus the light. Moreover, a switch 4 is disposed on the lamp body 1 and electrically connected to the control module 2 for manually operating the control module 2 to control the light source 12.

Specifically, the control module 2 has a control circuit 22 storing a plurality of control programs 23 for controlling the light source 12. Wherein the control programs 23 of the control circuit 22 include a flash mode 231, a sleep mode 232 and a hibernate mode 233.

In the flash mode 231, the light source 12 is flashed to achieve warning effect. In the sleep mode 232, the light source 12 is temporarily off When the vibration sensor 21 detects no vibration within a preset period, the control module 2 has the light source 12 change to the sleep mode 232; and once the vibration sensor 21 detects the vibration, the light source 12 is lighted up at the same time. In the hibernate mode 233, the light source 12 is turned off When the vibration sensor 21 detects no vibration over a preset period, the control module 2 has the light source 12 change to the sleep mode 233. In this manner, the intellectual bicycle lamp would improve unnecessary electrical consumption.

1. A bicycle lamp, comprising:
a lamp body having a light source disposed therein; and
a control module electrically connected to the light source for controlling the light source, and having a vibration sensor for detecting a vibration from the lamp body;
wherein the light source is turned on by the control module once the vibration sensor detects the vibration from the lamp body during riding, and the light source is turned off once the vibration sensor detect no vibration from the lamp body.

2. The bicycle lamp as claimed in claim 1, further comprising an ambient light sensor electrically connected to the light source and configured to detect an intensity of surrounding brightness and to control illumination of the light source according to the detected intensity of the surrounding brightness.

3. The bicycle lamp as claimed in claim 1, wherein the lamp body comprises a reflecting cup disposed around the light source, and a focusing lens disposed at a front side of the reflector cup opposite to the light source.

4. The bicycle lamp as claimed in claim 1, further comprising a switch disposed on the lamp body and electrically connected to the control module for manually controlling the control module.

5. The bicycle lamp as claimed in claim 1, wherein the control module has a control circuit storing a plurality of control programs for controlling the light source.

6. The bicycle lamp as claimed in claim 5, wherein the control programs of the control circuit include a flash mode in which the light source is flashed.

7. The bicycle lamp as claimed in claim 5, wherein the control programs of the control circuit include a sleep mode in which the light source is temporarily off; when the vibration sensor detects no vibration within a preset period, the control module has the light source change to the sleep mode; and once the vibration sensor detects the vibration, the light source is lighted up.

8. The bicycle lamp as claimed in claim 5, wherein the control programs of the control circuit include a hibernate mode in which the light source is turned off; when the vibration sensor detects no vibration over a preset period, the control module has the light source change to the sleep mode.
